(19) United States
(12) Patent Application Publication
(10) Pub. No.: US 2003/0078979 A1
(43) Pub. Date: Apr. 24, 2003

(54) Method and apparatus for controlling an intelligent device through an instant messaging protocol over a communication network

(75) Inventor: Uday C. Sagi, Fort Worth, TX (US)

Correspondence Address: LAW OFFICES OF DAVID G. POSZ, 2000 L STREET, N.W., SUITE 200, WASHINGTON, DC, 20036, US

(73) Assignee: MOTOROLA, INC.

(21) Appl. No.: 10/008,452

(22) Filed: Oct. 22, 2001

(51) Int. Cl. G06F 15/16; G06F 15/173

(52) U.S. Cl. 709/206; 709/223

(57) ABSTRACT

An intelligent device (108, 114) and a control station (102, 112) including respective IM clients are coupled (502) to a communication network (100). A user adds (508) the intelligent device to an IM “buddy” list (420) in the control station, and thereafter controls (510) the intelligent device from the control station by sending the intelligent device an instant message including a command from the control station.

### FIELD OF THE INVENTION

This invention relates in general to data communication systems, and more specifically to a method and apparatus for controlling an intelligent device through an Instant Messaging protocol over a communication network.

### BACKGROUND OF THE INVENTION

Intelligent devices are increasing in popularity throughout the world. Such devices can include kitchen appliances, automobiles, temperature controllers, celestial telescopes, VCRs, lighting, and computer peripherals, to name a few. As more features are added, these intelligent devices can become difficult for users to setup and control. Furthermore, prior-art methods of networking and controlling the intelligent devices have lacked standardization, adding to the confusion. An Instant Messaging protocol and system has recently emerged for transmitting messages among users logged onto a communication network.

However, what is needed is a method and apparatus for controlling an intelligent device through an Instant Messaging protocol over a communication network. Preferably, the method and apparatus will bring both standardization and simplification of setup and control by a user.

### BRIEF DESCRIPTION OF THE DRAWINGS

Additional objects and advantages of the present invention will be more readily apparent from the following detailed description of preferred embodiments thereof when taken together with the accompanying drawings in which:

FIG. 1 is an electrical block diagram of an exemplary communication network in accordance with the present invention;

FIG. 2 is an electrical block diagram of an exemplary intelligent device in accordance with the present invention;

FIG. 3 is an electrical block diagram of an exemplary intermediate controller in accordance with the present invention;

FIG. 4 is an electrical block diagram of an exemplary control station in accordance with the present invention; and

FIG. 5 is a flow diagram depicting operation of the exemplary communication network in accordance with the present invention.

### DETAILED DESCRIPTION OF THE DRAWINGS

In overview form the present disclosure concerns communications networks, devices, and methods suitable for controlling an intelligent device through or using an Instant Messaging system and protocol over a communication network, preferably, in a fashion that will bring both standardization and simplification of setup and control to a user. As further discussed below various inventive principles and combinations thereof are advantageously employed to make available control instructions so as to control intelligent devices provided these principles or equivalents are utilized.

The instant disclosure is provided to explain in an enabling fashion the best modes of making and using various embodiments in accordance with the present invention. The disclosure is further offered to enhance an understanding and appreciation for the inventive principles and advantages thereof, rather than to limit in any manner the invention. The invention is defined solely by the appended claims including any amendments made during the pendency of this application and all equivalents of those claims as issued.

It is further understood that the use of relational terms such as first and second, top and bottom, and the like, if any, are used solely to distinguish one from another entity, item, or action without necessarily requiring or implying any actual such relationship or order between such entities, items, or actions. Much of the inventive functionality and many of the inventive principles are best implemented with or in software programs or instructions. It is expected that one of ordinary skill, notwithstanding possibly significant effort and many design choices motivated by, for example, available time, current technology, and economic considerations, when guided by the concepts and principles disclosed herein will be readily capable of generating such software instructions and programs with minimal experimentation. Therefore further discussion of such software, if any, will be limited in the interest of brevity and minimization of any risk of obscuring the principles and concepts in accordance with the present invention.

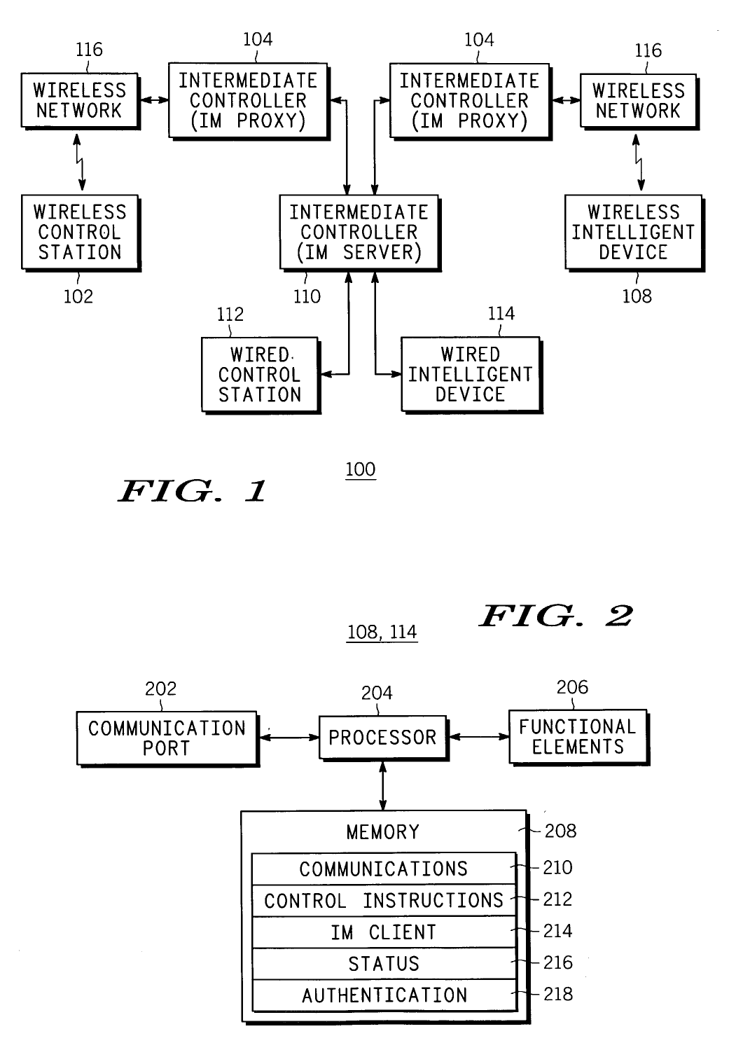

The present disclosure will discuss various embodiments in accordance with the invention. The system diagram of FIG. 1 will be used to lay the groundwork for a deeper understanding of the present invention and advantages thereof. FIG. 1 in large part and at the simplified level depicted is a representative diagram of a network 100 and will serve to explain the problems and certain inventive solutions thereto according to the present invention.

Referring to FIG. 1, an electrical block diagram of an exemplary communication network 100 in accordance with the present invention comprises a wired control station 112, which communicates with a wired intelligent device 114 through an intermediate controller 110, which serves as an Instant Messaging (IM) server. The communication network 100 further comprises a wireless control station 102, which communicates with the intermediate controller 110 through a wireless network 116 and an intermediate controller 104, which serves as an IM proxy on behalf of the wireless control station 102. A wireless intelligent device 108 also communicates with the intermediate controller 110 through the wireless network 116 and the intermediate controller 104, which serves as a proxy for the wireless intelligent device 108. It will be appreciated that the intermediate controllers 104, 110 can be separate devices, as shown, or, alternatively, can be combined into fewer devices or into a single device, as a matter of design choice.

Briefly, in accordance with the present invention, the control stations 102, 112 and the intelligent devices 108, 114 all have IM client software installed and operating therein. When a user of one of the control stations 102, 112 wishes to control one of the intelligent devices 108, 114, the user adds the one of the intelligent devices 108, 114 to an IM “buddy” list in the one of the control stations 102, 112. The user can then control the one of the intelligent devices 108, 114 by sending an instant message containing a command known to the one of the intelligent devices 108, 114. The one of the intelligent devices 108, 114 reports its status, e.g., on, off, to the one of the control stations 102, 112 through a selected IM “presence” indication, which is displayed at the user's control station 102, 112. Operational details will be disclosed further herein below.

Referring to FIG. 2, an electrical block diagram of an exemplary intelligent device 108, 114 in accordance with the present invention comprises a communication port 202 for coupling the intelligent device 108, 114 to the wireless network 116 and controller 110, respectively. The communication port 202 is coupled to a conventional processor for controlling the intelligent device 108,114. The wireless intelligent device 108 and the wired intelligent device 114 are similar to one another, the essential difference being that in the wireless intelligent device 108 the communication port 202 comprises a conventional wireless communication element, such as a cellular telephone transceiver operating with a known protocol such as the Wireless Access Protocol (WAP), while in the wired intelligent device 114 the communication port 202 comprises a conventional wired communication element, such as a serial interface and modem.

In addition, the intelligent device 108,114 includes functional elements 206 for performing predetermined functions under control of the processor 204. When the intelligent device 108, 114 is a video cassette recorder (VCR), for example, a predetermined function performed is channel selection. The intelligent device 108, 114 also includes a memory 208 coupled to the processor 204, comprising operating variables and software programs for programming the processor 204 in accordance with the present invention. The memory 208 includes a communications program 210 for programming the processor 204 to perform the communications required in accordance with the present invention. In addition, the memory 208 includes a location for control instructions 212 received from one of the control stations 102,112 through the communication port 202. The memory 208 also preferably includes an IM client program 214 for programming the processor 204 to receive the control instructions 212 as instant messages, using a wellknown IM protocol, such as used in AOL Messenger or Yahoo Messenger. The memory 208 also includes a status program 216 for determining a status of the intelligent device 108,114 and transmitting the status as an IM “presence” indicator. Examples of status indications are “on”, “off”, “low battery”, “alarm”, etc. Status indications for a specific device are necessarily device dependent. The memory 208 preferably further comprises an authentication program 218 for authenticating the IM server 110 or the IM proxy 104 when the intelligent device 114 or 108, respectively, receives an instant message.

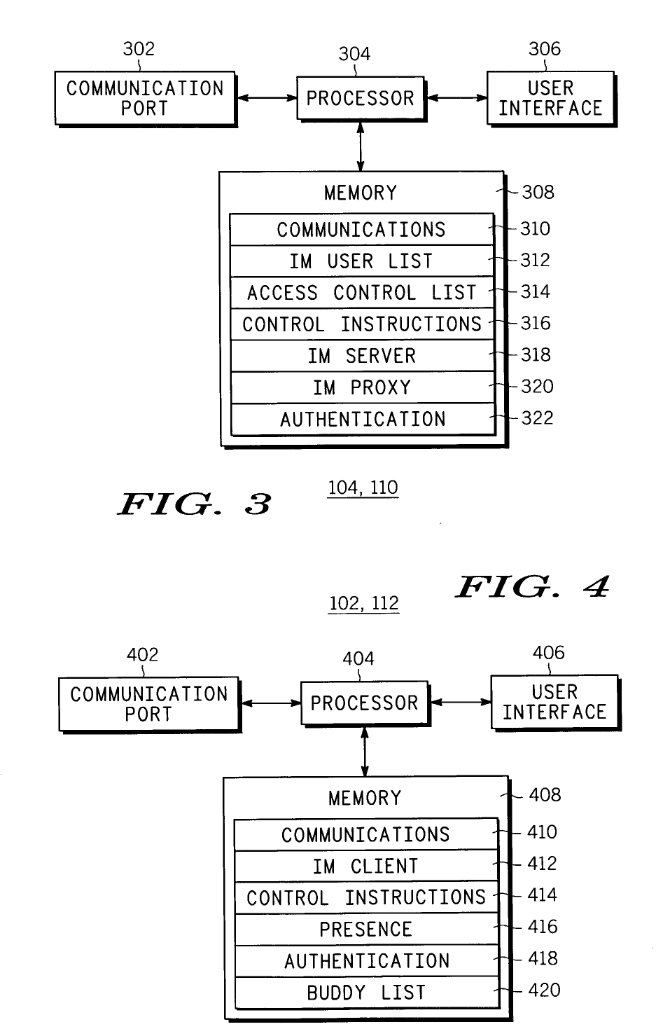

Referring to FIG. 3, an electrical block diagram of an exemplary intermediate controller 104,110 in accordance with the present invention comprises at least one communication port 302 and likely more for communicating with the intelligent device 108,114 and the control station 102,112. The intermediate controller 104, 110 further comprises a processor 304 coupled to the communication port 302 for directing operations of the intermediate controller 104,110. A user interface 306, e.g., a conventional display and keypad, is also coupled to the processor 304 for control and programming of the intermediate controller 104,110 by a user or operator. The intermediate controller 104, 110 further comprises a memory 308 coupled to the processor 304, comprising operating variables and software programs for programming the processor 304 in accordance with the present invention.

The memory 308 includes a communications program 310 for programming the processor 304 to perform the communications required in accordance with the present invention. In addition, the memory 308 includes a location for an IM user list 312 programmed by the user, identifying users that are authorized to send control instructions to a specific intelligent device 108, 114. The memory 308 also includes an access control list 314 for controlling, through well-known techniques, the use of specific control instructions by specific users. For example, when the intelligent device 108, 114 is a VCR, a parent can use the access control list 314 to prevent a child from recording a specific program.

In addition, the memory 308 comprises a location for storing control instructions 316 in the form of instant messages that are handled by the intermediate controller 104,110. In the case of the intermediate controller 110, the memory 308 includes an IM server program 318 for programming the processor 304 to act as an IM server through well-known techniques. In the case of the intermediate controller 104, the memory 308 includes an IM proxy program 320 for programming the processor 304 to act as an IM proxy on behalf of the wireless intelligent device 108 and the wireless control station 102, through known techniques. The memory 308 also preferably includes an authentication program 322 for programming the processor 304 to authenticate the user when receiving an instant message for the intelligent device 108,114. The authentication program 322 preferably also programs the processor 304 to authenticate the intelligent device 108,114 when receiving an IM “presence” indication from the intelligent device 108, 114.

Referring to FIG. 4, an electrical block diagram of an exemplary control station 102, 112 in accordance with the present invention comprises a communication port 402 for coupling the control station 102, 112 to other devices in the communication network 100. As noted above with reference to intelligent device 108,114 the main difference between the communications ports on control stations 102,114 is that the port and supporting control hardware and software must interface to a wireless versus wired network, respectively. The control station 102,112 further comprises a processor 404 coupled to the communication port 402 for directing operations of the control station 102, 112, and a user interface 406, e.g., a conventional display and keypad, coupled to the processor 404 for interfacing with a user. The control station 102, 112 also includes a memory 408 coupled to the processor 404, comprising operating variables and software programs for programming the processor 404 in accordance with the present invention.

The memory 408 comprises a communications program 410 for programming the processor 404 to perform the communications required in accordance with the present invention. In addition, the memory 408 includes an IM client program 412 for programming the processor 404 to control the intelligent device 108,114 by sending the intelligent device 108,114 an instant message comprising a command. The memory 408 also includes a location for storing control instructions 414 in the form of instant messages that are input by the user through the user interface 406. The memory 408 further comprises a location for storing an IM “presence” indication 416 received from the intelligent device 108,114 to identify a status of the intelligent device 108, 114. The “presence” indication is preferably displayed to the user through the user interface 406. In addition, the memory 408 includes an authentication program 418 for programming the processor 404 to authenticate at least one of a server and a proxy (preferably in the form of the intermediate controller 104, 110) when receiving the IM “presence” indication. The memory 408 also includes a location for storing a “buddy” list. The “buddy” list is programmed by the user and identifies the intelligent devices 108, 114 that the user can control and whose status the user can see via the user interface 406.

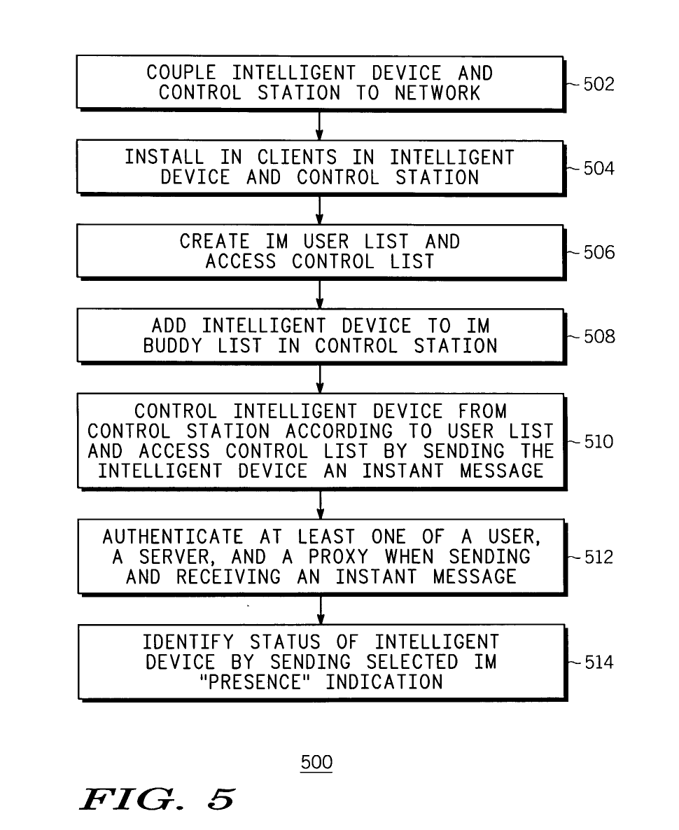

Referring to FIG. 5, a flow diagram 500 depicts operation of the exemplary communication network 100 in accordance with the present invention. The flow begins with coupling 502 the intelligent device 108, 114 and the control station 102,112 to the communication network 100. Next, IM client software is installed 504 in the intelligent device 108,114 and the control station 102,112. Then the IM user list 312 and the access control list 314 are created 506 in the intermediate controller 104, 110 appropriate for the type of control station 102,112. For the wireless control station 102, the intermediate controller 104 acting as an IM proxy is preferably utilized. For the wired control station 112, the intermediate controller 110 acting as an IM server is preferably utilized.

A user then adds 508 one of the intelligent devices 108,114 to the IM “buddy” list in his control station 102,112. The IM server 110 or IM proxy 104 verifies whether the user is authorized to control the one of the intelligent devices 108,114. If the user is authorized, the current status, e.g., “idle”, of the one of the intelligent devices 108,114 is sent to the user as a “presence” indicator. The user can then control 510 the intelligent device 108, 114 from the control station 102,112 in accordance with (i.e., when permitted by) the IM user list 312 and the access control list 314 by sending an instant message to the intelligent device 108, 114. When receiving the instant message, the server 110 or proxy 104 will authenticate 512 the user, and the intelligent device 108,114 will authenticate the server 110 or proxy 104 sending the instant message. In that manner, each device receiving a communication advantageously can confirm that the instant message is from a source authorized to communicate with the device. After receiving the instant message, the intelligent device 108, 114 indicates its status by sending 514 a selected IM “presence” indication to the control station(s) 102, 112 in which the intelligent device 108, 114 is a member of the “buddy” list.

It is envisioned that many different types of intelligent devices 108, 114, such as a smart car, a rice cooker, and a VCR, to name a few, can benefit from the present invention. A smart car, for example, can accept and respond to commands such as “start air”, “set temp”, “start engine”, and “unlock door”, and can send status indications, such as “theft alarm on”, “battery low”, “engine running”, “temp=xx”, “air on”, and “air off”. A rice cooker, for example, can accept “cook”, “warm”, and “off”, and can send status indications, such as “no water”. The intelligent devices 108, 114 respond to users' IM commands and change their status, which is then reflected on the “presence” status indication next to the device “buddy” name. The present invention advantageously will operate with existing Instant Messaging infrastructure and software services. A few new “presence” indicators will have to be added to accommodate the new status indications required for the intelligent devices 108, 114.

Thus, it should be clear from the preceding disclosure that the present invention provides a method and apparatus for controlling an intelligent device through an Instant Messaging protocol over a communication network. Advantageously, the method and apparatus brings both standardization and simplification of setup and control by a user.

Many modifications and variations of the present invention are possible in light of the above teachings. Thus, it is to be understood that, within the scope of the appended claims, the invention can be practiced other than as described herein above.

What is claimed is:

1. A method for controlling an intelligent device through an Instant Messaging (IM) protocol over a communication network, the method comprising the steps of:
coupling the intelligent device having a first IM client to a control station having a second IM client using the communication network;
adding the intelligent device to an IM “buddy” list in the control station; and
controlling the intelligent device from the control station by sending the intelligent device an instant message from the control station, the instant message comprising a command.

2. The method of claim 1, further comprising the step of identifying a status of the intelligent device to the control station by sending from the intelligent device to the control station a selected IM “presence” indication.

3. The method of claim 1, further comprising the steps of:
creating an IM user list and an access control list corresponding to the intelligent device and to a user; and
providing control of the intelligent device by the user in accordance with the access control list.

4. The method of claim 1, further comprising the step of authenticating at least one of a user, a server, and a proxy when sending and receiving an instant message.

5. An intelligent device arranged for control through an Instant Messaging (IM) protocol over a communication network by a control station having a first IM client installed therein and having the intelligent device in an IM “buddy” list of the control station, the intelligent device comprising:
a communication port for coupling the intelligent device to the communication network; and
a processor coupled to the communication port for controlling the intelligent device,
wherein the processor is programmed with a second IM client arranged to allow the intelligent device to be controlled from the control station through receiving an instant message from the control station, the instant message comprising a command.

6. The intelligent device of claim 5, wherein the processor is further programmed to identify a status of the intelligent device to the control station by sending from the intelligent device to the control station a selected IM “presence” indication.

7. The intelligent device of claim 5, wherein the processor is further programmed to authenticate at least one of a server and a proxy when receiving an instant message.

8. An intermediate controller for controlling an intelligent device through an Instant Messaging (IM) protocol over a communication network, the intermediate controller comprising:
a processor; and
a communication port coupled to the processor for communicating with the intelligent device through the communication network, wherein the processor is programmed to:
create an IM user list and an access control list corresponding to the intelligent device and to a user; and
provide IM control of the intelligent device by the user in accordance with the access control list.

9. The intermediate controller of claim 8, wherein the processor is further programmed to serve as an IM server.

10. The intermediate controller of claim 8, wherein the processor is further programmed to serve as a wireless network proxy.

11. The intermediate controller of claim 8, wherein the processor is further programmed to authenticate the user when receiving an instant message for the intelligent device.

12. The intermediate controller of claim 8, wherein the processor is further programmed to authenticate the intelligent device when receiving an IM “presence” indication from the intelligent device.

13. A control station for controlling an intelligent device through an Instant Messaging (IM) protocol over a communication network, the intelligent device having a first IM client installed therein, the control station comprising:
a communication port for coupling the control station to the communication network;
a processor coupled to the communication port for directing operations of the control station, and a user interface coupled to the processor for interfacing with a user;
wherein the processor is programmed with a second IM client for controlling the intelligent device by sending the intelligent device an instant message comprising a command.

14. The control station of claim 13, wherein the processor is further programmed to identify a status of the intelligent device by receiving from the intelligent device a selected IM “presence” indication.

15. The control station of claim 13, wherein the processor is further programmed to authenticate at least one of a server and a proxy when receiving an IM “presence” indication.
